(19) United States
(12) Patent Application Publication
(10) Pub. No.: US 2026/0359088 A1
(43) Pub. Date: Nov. 12, 2026

(54) OPERATION METHOD FOR A VIRTUAL MACHINE, HYPERVISOR, OR SECURE OPERATING SYSTEM, AND DEVICE, SYSTEM, COMPUTER-READABLE STORAGE MEDIUM, AND COMPUTING DEVICE FOR THE SAME

(71) Applicant: SAMSUNG ELECTRONICS CO., LTD., Suwon-si (KR)

(72) Inventors: Bo SUN, Suwon-si (KR); Zhen GAO, Suwon-si (KR); Mindong ZHAO, Suwon-si (KR); Peng HUANG, Suwon-si (KR); Si-Heung KIM, Suwon-si (KR)

(73) Assignee: SAMSUNG ELECTRONICS CO., LTD., Suwon-si (KR)

(21) Appl. No.: 19/284,147

(22) Filed: Jul. 29, 2025

(30) Foreign Application Priority Data
May 9, 2025 (CN) 202510599918.0

(51) Int. Cl. G06F 9/455; G06F 21/53

(52) U.S. Cl. CPC G06F 9/45533; G06F 21/53

(57) ABSTRACT

An operation method and device, system, a computer-readable storage medium, and a computing device are provided. The operation method for a Hypervisor includes acquiring a first message, that is to be sent from a virtual machine to a secure operating system, the secure operating system being registered in a middleware of the Hypervisor, the first message including a first storage location information, the first storage location information being associated with a first location in a memory in the middleware associated with the virtual machine and the secure operating system; sending the first message to the secure operating system; receiving, from the secure operating system, a second message, the second message being based on the first message and including a second storage location information, the second storage location information being associated with a second location in a memory in the middleware; and sending the second message to the virtual machine.

### CROSS-REFERENCE TO RELATED APPLICATION

The present application claims priority from Chinese Patent Application No. 202510599918.0, filed on May 9, 2025, with the China Intellectual Property Office and all the benefits accruing therefrom under 35 U.S.C. 119, the contents of which are incorporated herein by reference in their entireties.

### BACKGROUND

The present disclosure relates to an operation method for a Hypervisor, an operation method for a secure operating system, an operation method for a virtual machine. The present disclosure is also related to a Hypervisor, a secure operating system, a virtual machine, a virtual machine operating system, a computer-readable storage medium, and a computing device.

A Trusted Execution Environment (TEE) is a secure execution environment in which a secure operating system (Secure OS) runs. A regular operating system (e.g., Linux, Android, or QNX) runs in a so-called Rich Execution Environment (REE). The secure operating system in the TEE and the regular operating system in the REE can run simultaneously. Trusted services in the Secure OS can provide critical security functions to the regular OS. With widespread use of a virtualization technology, multi-virtual machines are becoming more common. Multiple operating systems, e.g., Linux and Android, can run simultaneously on a hypervisor and both require trusted services from the secure operating system. In an Android virtual machine, applications such as gatekeeper, key master, and DRM (Digital Rights Management) require trusted services from the secure operating system. In a Linux virtual machine, DRM and other applications that require critical security features also require trusted services from the secure operating system.

Some related techniques enable the secure operating system to support multiple virtual machines (VMs).

A first technique enables the secure OS to support multiple VMs by adding modules into the secure OS and the Hypervisor. In this technique, a module is added into the Hypervisor layer for transforming an intermediate physical address (IPA) into a physical address (PA) during communication between the VM and the secure OS. Then, a VM isolation module is added into the secure OS side to maintain state and address isolation of the VMs. The VM isolation module needs to know how many VMs there are in the rich execution environment and allocate separate memory for each VM to manage the state and code segments of each VM.

The first technique lacks flexibility because it only supports static configuration of the number of VMs. That is, the VM isolation module in the first technique allocates memory to each VM based on a static configuration even if some VMs are not running, which can lead to a waste of resources. This technique is also specific to the secure operating system and the Hypervisor, which makes it difficult to change the secure operating system, therefore, the first technique lacks scalability.

A second technique enables the secure operating system to support multiple virtual machines by using a front-end driver and a back-end driver in the virtual machine. The second technique involves adding a back-end driver into a virtual machine called a system domain and adding a front-end driver into every other virtual machine. The other virtual machines communicate with the system domain through the front-end driver, and the back-end driver is responsible in the system domain for forwarding all messages from the front-end driver to the secure operating system and completing all communications with the secure operating system.

The second technique lacks scalability due to the weak scalability of the back-end driver and the front-end driver, each of which require different implementations for different types of VMs (e.g., Linux, Android, and QNX). Although the second technique does not need to amend the secure operating system, it adds additional copies of the data, and the front-end driver's requests are sent to the back-end driver through a private protocol, and the back-end driver processes these requests. Because parameters and data are repeatedly processed and copied in this procedure, the second technique has lower efficiency. Additionally, the second technique exposes front-end data to the back-end, leading to poorer security.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

Exemplary embodiments of the present disclosure provide an operation method and device, system, computer-readable storage medium, and computing device, to support use of functions and services of secure operating system across multiple virtual machines, thereby improving scalability, security, and flexibility of operations of a virtual machine, and improving operation efficiency of the virtual machine.

According to an embodiment of the present disclosure, an operation method for a Hypervisor is disclosed. The operation method includes acquiring a first message, the first message being a message to be sent from a virtual machine to a secure operating system, the secure operating system being registered in a middleware of the Hypervisor, wherein the first message comprises a first storage location information of data associated with the first message, the first storage location information being associated with a first location in a memory in the middleware associated with the virtual machine and the secure operating system; sending the first message to the secure operating system; receiving, from the secure operating system, a second message, the second message being based on the first message, wherein the second message comprises a second storage location information of a result based on processing the first message, the second storage location information being associated with a second location in a memory in the middleware; and sending the second message to the virtual machine.

According to an embodiment of the present disclosure, an operation method for a secure operating system is provided. The operation method includes receiving a first message, the first message being a message sent from a middleware of a Hypervisor, wherein the first message comprises a first storage location information of data associated with the first message, the first storage location information being associated with a first location in a memory in the middleware associated with the virtual machine and the secure operating system; obtaining a second message based on the first message, wherein the second message comprises a second storage location information of a result based on processing the first message, the second storage location information being associated with a second location in a memory in the middleware; and sending the second message to the middleware.

According to an embodiment of the present disclosure, an operation method for a virtual machine is provided. The operation method includes transmitting a first message, the first message being a message to a secure operating system based on a call instruction, wherein the first message comprises a first storage location information of data associated with the first message, the first storage location information being associated with a first location in a memory in the middleware associated with the virtual machine and the secure operating system; receiving a second message from the middleware, the second message being obtained by the secure operating system based on the first message, wherein the second message comprises a second storage location information of a result based on processing the first message; and determining an operation result based on the second message.

According to an embodiment of the present disclosure, a virtual machine operating system includes at least one virtual machine; at least one secure operating system; a Hypervisor, comprising a middleware, wherein the middleware is connected to the at least one virtual machine, and wherein the at least one secure operating system is registered with the middleware; and a secure monitor, connected to the middleware and the at least one secure operating system, wherein one or more processors in the middleware are configured to: acquire a first message, the first message being a message to be sent from the at least one virtual machine to the at least one secure operating system, wherein the first message comprises a first storage location information of data associated with the first message, the first storage location information being associated with a first location in a memory in the middleware associated with the virtual machine and the secure operating system; send the first message to the at least one secure operating system; receive, from the at least one secure operating system, a second message, the second message being based on the first message, wherein the second message comprises a second storage location information of a result based on processing the first message, the second storage location information being associated with a second location in a memory in the middleware; and send the second message to the at least one virtual machine.

According to an embodiment of the present disclosure, a hypervisor is provided. The hypervisor includes a message acquiring unit, configured to acquire a first message, the first message being a message to be sent from a virtual machine to a secure operating system registered in a middleware of the Hypervisor, wherein the first message comprises a first storage location information of data associated with the first message, the first storage location information being associated with a first location in a memory in the middleware associated with the virtual machine and the secure operating system; a message sending unit, configured to send the first message to the secure operating system; a processed message receiving unit, configured to receive, from the secure operating system, a second message, the second message being based on the first message, wherein the second message comprises a second storage location information of a result based on processing the first message, the second storage location information being associated with a second location in a memory in the middleware; and a processed message sending unit, configured to send the second message to the virtual machine.

According to an embodiment of the present disclosure, a secure operating system is provided. The secure operating system includes a message receiving unit, configured to receive a first message sent, the first message being a message sent from a middleware of a Hypervisor, wherein the first message comprises a first storage location information of data associated with the first message, the first storage location information being associated with a first location in a memory in the middleware associated with the virtual machine and the secure operating system; a message processing unit, configured obtain a second message based on the first message, wherein the second message comprises a second storage location information of a result based on processing the first message, the second storage location information being associated with a second location in a memory in the middleware; and a message sending unit, configured to send the second message to the middleware.

According to an embodiment of the present disclosure, a virtual machine is provided. The virtual machine includes an instruction transmitting unit, configured to transmit a first message, the first message being a message to a secure operating system based on a call instruction, wherein the first message comprises a first storage location information of data associated with the first message, the first storage location information being associated with a first location in a memory in the middleware associated with the virtual machine and the secure operating system; a message receiving unit, configured to receive a second message, the second message being obtained by the secure operating system based on the first message, wherein the second message comprises a second storage location information of a result based on processing the first message; and an operation result determining unit, configured to determine an operation result based on the second message.

According to an embodiment of the present disclosure, a computer-readable storage medium storing is provided. The computer program, when executed by a processor, implements the operation methods disclosed herein.

According to an embodiment of the present disclosure, a computing device is provided. The computing device includes at least one processor; and at least one memory storing a computer program that, when executed by the at least one processor, implements the operation methods disclosed herein.

Additional aspects and/or advantages of the general concept of the present disclosure will be partially explained in the following description, and still others will be clear from the description, or may be known through the implementation of the general concept of the present disclosure.

### BRIEF DESCRIPTION OF DRAWINGS

The above and other features of exemplary embodiments of the present disclosure will become clearer through the following description in conjunction with the drawings that exemplarily illustrate embodiments, wherein:

FIG. 1 illustrates a flowchart of a process for a Hypervisor according to an exemplary embodiment of the present disclosure;

FIG. 2 illustrates a flowchart of a process for a secure operating system according to an exemplary embodiment of the present disclosure;

FIG. 3 illustrates a flowchart of a process for a virtual machine according to an exemplary embodiment of the present disclosure;

FIG. 4 illustrates a block diagram of a Hypervisor according to an exemplary embodiment of the present disclosure;

FIG. 5 illustrates a block diagram of a secure operating system according to an exemplary embodiment of the present disclosure;

FIG. 6 illustrates a block diagram of a virtual machine according to an exemplary embodiment of the present disclosure;

FIG. 7 illustrates a schematic diagram of a virtual machine operating system according to an exemplary embodiment of the present disclosure;

FIG. 8 illustrates a schematic diagram of a computing device according to an exemplary embodiment of the present disclosure.

### DETAILED DESCRIPTION

Reference will be made in detail to exemplary embodiments of the present disclosure, examples of which are illustrated in the drawings, wherein like reference numerals refer to like elements throughout the drawings. The embodiments will be described below by reference to the accompanying drawings in order to explain the present disclosure.

It is to be understood that the singular forms include plural forms, unless the context clearly indicates otherwise. The terms “include”, “comprise”, and “have” used herein, indicate disclosed functions, operations, or the existence of elements, but do not exclude other functions, operations, or elements.

The expressions “A or B,” or “at least one of A and B” may indicate A and B, A, or B. For instance, the expression “A or B” or “at least one of A and B” may indicate (1) A, (2) B, or (3) both A and B.

In various example embodiments of the present disclosure, it is intended that when a component (for example, a first component) is referred to as being “coupled” or “connected” with/to another component (for example, a second component), the component may be directly connected to the other component or may be connected through another component (for example, a third component). In contrast, when a component (for example, a first component) is referred to as being “directly coupled” or “directly connected” with/to another component (for example, a second component), another component (for example, a third component) does not exist between the component and the other component.

The expression “configured to” used in describing various embodiments of the present disclosure, may be used interchangeably with expressions such as “suitable for”, “having the capacity to . . . ”, “designed to”, “adapted to”, “made to” and “capable of”, for example, according to the situation. The term “configured to” may not necessarily indicate “specifically designed to” in terms of hardware. Instead, the expression “a device configured to . . . ” in some situations may indicate that the device and another device or part are “capable of . . . ”. For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device. is the present disclosure relates to implementing a function of supporting a secure operating system for multiple VMs by only adding a module into the Hypervisor. The present disclosure enables applications in multiple VMs to use the function of the secure operating system through a middleware in the Hypervisor without any amendments to the secure operating system.

Application scenarios for the present disclosure may include, for example, but are not limited to, an application scenario where a user of automotive system expects to utilize features of the secure operating system across multiple VMs to easily add or remove a VM, an application scenario in which the user expects to be able to easily change the secure operating system and can significantly reduce the workload.

In the present disclosure, the use of the middleware only in the Hypervisor is used as an example of a function of supporting the secure operating system feature for multiple virtual machines.

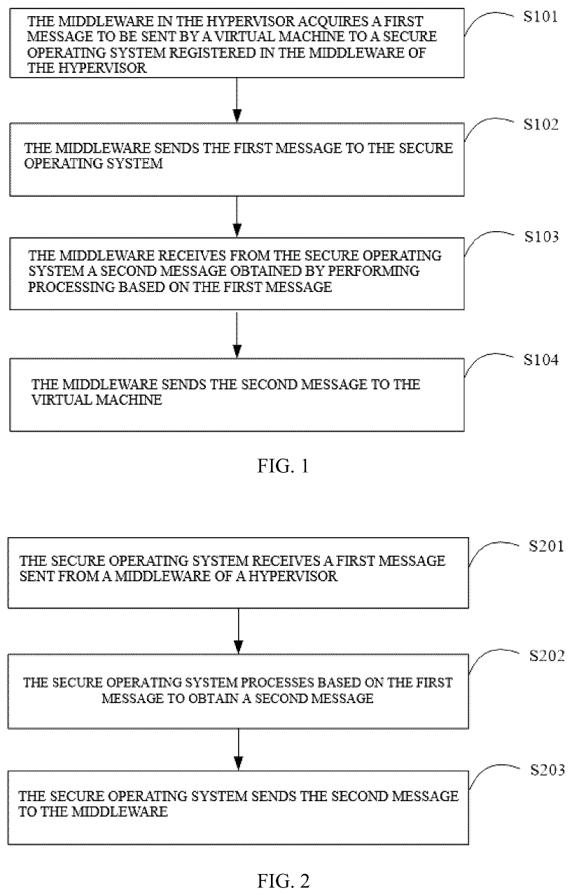

FIG. 1 illustrates a flowchart of an operation method for a Hypervisor according to an exemplary embodiment of the present disclosure. The operation method of the Hypervisor in FIG. 1 may be executed by a middleware in the Hypervisor. In the present disclosure, performing the operation method for the Hypervisor by the middleware in the Hypervisor is illustrated as an example, and the present disclosure is not limited thereto.

Referring to FIG. 1, in operation S101, the middleware in the Hypervisor acquires a first message to be sent by a virtual machine to a secure operating system registered in the middleware of the Hypervisor. In embodiments, the first message may include first storage location information of data associated with the first message in a shared memory, and the shared memory is located in the middleware. For example, the secure operating system is located in a trusted execution environment. For example, the shared memory may be a World Shared Memory (WSM), and the first storage location information may be a shared memory identity or the World Shared Memory identity (WSM ID).

In an exemplary embodiment of the present disclosure, the acquiring of the first message to be sent by the virtual machine to the secure operating system registered in the middleware of the Hypervisor may include: acquiring transmission messages transmitted by the virtual machine through a call instruction; determining a target transmission message in the transmission messages whose destination is the secure operating system; and determining the first message based on the target transmission message, thereby filtering out messages that are not to be send to the secure operating system to improve efficiency.

For example, the middleware may acquire a transmission message transmitted by the virtual machine through a call instruction, by way of interception. In an embodiment of the present disclosure, the middleware may acquire messages from multiple different virtual machines by way of interception. Herein, the call instruction may be, for example, but not limited to, a Secure Monitor Call (SMC) instruction.

In an exemplary embodiment of the present disclosure, the first message may further include a virtual machine flag, the virtual machine flag may be used to indicate a virtual machine corresponding to the first message, thus marking the first message as associated with its corresponding virtual machine.

In an exemplary embodiment of the present disclosure, the determining of the first message based on the target transmission message may include: appending the virtual machine flag into a session field of the target transmission message; and determining the target transmission message with the virtual machine flag appended as the first message. This is an exemplary implementation of the marking of the first message. For example, if the destination of the transmission message is the secure operating system, the middleware determines that the transmission message is the target transmission message. Then, the middleware decodes the target transmission message, and appends the virtual machine flag into the session field of the target transmission message, thereby obtaining the first message.

In an exemplary embodiment of the present disclosure, the first message may further include a function that the virtual machine needs the secure operating system to complete.

Specifically, the function that the virtual machine needs the secure operating system to complete in the first message may represent the function that the virtual machine wants the secure operating system to complete. The function that the virtual machine needs the secure operating system to complete may be a customized function, such as, but not limited to, a function such as encrypting data, decrypting data, etc.

The world shared memory identity (WSM ID) is an integer greater than or equal to 0, the world shared memory identity (WSM ID) represents information about where data is stored in the World Shared Memory.

In embodiments, the world shared memory is a memory that may be accessed by the virtual machine and the secure operating system simultaneously, and each message may correspond to a piece of world shared memory. In an embodiment of present disclosure, the size of a message may be small (e.g., but not limited to, only 64 byte) with the message including no specific relevant data, only the world shared memory identity, i.e., an integer greater than or equal to 0. Other information and large chunks of data about the message may be stored in the world shared memory. When the secure operating system receives the message, it may find the physical address of the world shared memory corresponding to the message through the world shared memory identity. It may then remove the chunk of data from the world shared memory and processes the chunk of data. Finally, it may store the result of the processing in the world shared memory. The middleware may then look up the physical address of the world shared memory from a hash table associated with the world shared memory identity, access the world shared memory and obtain the result of the processing of the message as needed.

In operation S102, the middleware sends the first message to the secure operating system.

In an exemplary embodiment of the present disclosure, the sending of the first message to the secure operating system may include: converting address information in the first message into a physical address; and sending the first message—whose address has been converted—to the secure operating system through a secure monitor. The destination of the first message is determined when the address information is converted into a physical address, enabling accurate transmission of the first message. Herein, the address information in the first message may be, for example, but not limited to, an intermediate physical address. For example, the middleware converts the intermediate physical address in the first message into a physical address and records it.

In operation S103, the middleware receives, from the secure operating system, a second message obtained based on performing processing based on the first message. Herein, the second message may include second storage location information associated with a result of the processing in the shared memory.

In an exemplary embodiment of the present disclosure, the second message may further include the virtual machine flag, facilitating the determination of the virtual machine corresponding to the second message.

In operation S104, the middleware sends the second message to the virtual machine.

In an exemplary embodiment of the present disclosure, the sending of the second message to the virtual machine may include: determining the virtual machine that is indicated by the virtual machine flag included in the second message; and sending the second message-with the virtual machine flag removed-to the virtual machine. That is, according to some embodiments, the second message may be sent to the virtual machine with the virtual machine flag removed. The distribution of the returned second message may be implemented based on the virtual machine flag, improving the accuracy of the sending of the second message. That is, since the second message includes the virtual machine flag, the middleware may correctly distribute the second message to the corresponding virtual machine.

As an example, assuming that the middleware intercepts the first message sent by the virtual machine, where the content of the first message is a function of (decryption) +WSM ID (1). The middleware then sends the first message to the secure operating system. This will cause the secure operating system to, upon receipt of the first message, read the data from the world-shared memory with a WSM ID of 1 and to perform a decryption operation on the data. The secure operating system may then put the result back into the world shared memory with a WSM ID of 1 and send the second message to the middleware. The middleware removes the virtual machine flag from the second message, and sends the second message to a virtual machine indicated by the virtual machine flag.

According to the exemplary embodiments of the present disclosure, the secure operating system for multiple virtual machines supported by using the middleware only in the Hypervisor, so that there is no need to amend the secure operating system and the virtual machines. This makes it more convenient to support multiple secure operating systems in the Hypervisor. This also improves scalability. Finally, it improves efficiency by using the shared memory in the middleware to send data and a result of the processing on the data, all without exposing the data and the result of the processing on the data.

FIG. 2 illustrates a flowchart of an operation method for a secure operating system according to an exemplary embodiment of the present disclosure.

Referring to FIG. 2, in operation S201, the secure operating system receives a first message sent from a middleware of a Hypervisor. Herein, the first message may include first storage location information of data associated with the first message in a shared memory, and the shared memory is located in the middleware. In an exemplary embodiment of the present disclosure, for example, the secure operating system may be located in a trusted execution environment.

In an exemplary embodiment of the present disclosure, the first message may further include a virtual machine flag, and the virtual machine flag may be used to indicate a virtual machine corresponding to the first message, thus marking the first message.

In an exemplary embodiment of the present disclosure, the first message may further include a function that the virtual machine needs the secure operating system to complete. Thus enabling the secure operating system to perform the function.

In operation S202, the secure operating system processes based on the first message to obtain a second message. The second message may include second storage location information associated with a result of the processing in the shared memory. In the present disclosure, because the secure operating system may be located in a trusted execution environment, the processing performed by the secure operating system based on the first message may also be referred to as trusted service processing.

In an exemplary embodiment of the present disclosure, the performing of the processing based on the first message may include: acquiring data associated with the first message from the shared memory based on first storage location information; and processing the acquired data associated with the first message. This avoids sending data insecurely because the first stored location information associated with the storage location of the data is shared in the first message.

In an exemplary embodiment of the present disclosure, the processing of the acquired data associated with the first message may include: processing the acquired data associated with the first message based on the function.

In operation S203, the secure operating system sends the second message to the middleware.

In an exemplary embodiment of the present disclosure, the second message may further include the virtual machine flag, enabling identification of the virtual machine corresponding to the second message.

According to the exemplary embodiments of the present disclosure, the secure operating system processes the data in the shared memory based on the first message and stores the result of the processing in the shared memory. That is, it improves security and efficiency, by making it unnecessary to send the data and the result of the processing on the data by using the shared memory in the middleware. In addition, in the present disclosure, there is no need to amend the secure operating system, thus the process as shown in FIG. 2 can be applied to any secure operating system. Therefore, the secure operating system can be easily replaced in the present disclosure.

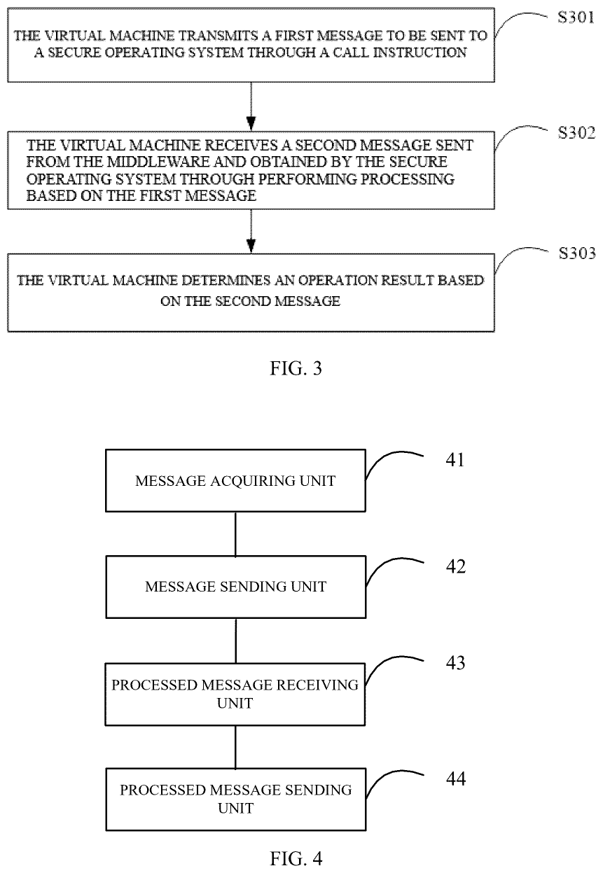

FIG. 3 illustrates a flowchart of an operation method for a virtual machine according to an exemplary embodiment of the present disclosure. The operation method for the virtual machine in FIG. 3 may be performed by any virtual machine known to a person of skill in the art.

Referring to FIG. 3, in operation S301, the virtual machine transmits a first message to be sent to a secure operating system through a call instruction. Herein, the first message may include first storage location information of data associated with the first message in a shared memory, and the shared memory is located in the middleware included in a Hypervisor. In the present disclosure, for example, the secure operating system may be located in a trusted execution environment.

In operation S302, the virtual machine receives a second message sent from the middleware and obtained by the secure operating system through performing processing based on the first message. Herein, the second message may include second storage location information of a result of the processing in the shared memory.

In operation S303, the virtual machine determines an operation result based on the second message.

In an exemplary embodiment of the present disclosure, the determining of the operation result based on the second message may include: acquiring the result of the processing from the shared memory based on the second storage location information; and determining the acquired result of the processing as the operation result. Using the shared memory in the middleware makes it unnecessary to send the result of the processing on the data. This also does not expose the result of the processing on the data, improving security and efficiency.

Furthermore, the exemplary embodiments of the present disclosure reduce redundant data replication between virtual machines, thereby avoiding the risk of data exposure and improving security and efficiency.

The operation method according to the exemplary embodiments of the present disclosure has been described above in conjunction with FIG. 1~FIG. 3. Hereinafter, a Hypervisor and units thereof, a secure operating system and units thereof, and a virtual machine and units thereof according to an exemplary embodiment of the present disclosure will be described with reference to FIG. 4~FIG. 6. A virtual machine operating system according to an exemplary embodiment of the present disclosure will be described with reference to FIG. 7.

FIG. 4 illustrates a block diagram of a Hypervisor according to an exemplary embodiment of the present disclosure.

Referring to FIG. 4, the Hypervisor includes a message acquiring unit 41, a message sending unit 42, a processed message receiving unit 43, and a processed message sending unit 44.

The message acquiring unit 41 is configured to acquire a first message to be sent by a virtual machine to a secure operating system registered in a middleware of the Hypervisor. The first message includes first storage location information of data associated with the first message in a shared memory where the shared memory is located in the middleware. In the present disclosure, for example, the secure operating system may be located in a trusted execution environment.

In an exemplary embodiment of the present disclosure, the message acquiring unit 41 may be configured to: acquire transmission messages transmitted by the virtual machine through a call instruction; determine a target transmission message in the transmission messages whose destination is the secure operating system; and determine the first message based on the target transmission message. In embodiments, the call instruction may be, for example, but not limited to, a Secure Monitor Call instruction.

In an exemplary embodiment of the present disclosure, the first message may further include a virtual machine flag, and the virtual machine flag may be used to indicate a virtual machine corresponding to the first message.

In an exemplary embodiment of the present disclosure, the message acquiring unit 41 may be configured to: append the virtual machine flag into a session field of the target transmission message; and determine the target transmission message with the virtual machine flag appended as the first message. That is, in embodiments, the message acquiring unit 41 may mark the first message as corresponding to the virtual machine.

The message sending unit 42 is configured to send the first message to the secure operating system.

In an exemplary embodiment of the present disclosure, the message sending unit 42 may be configured to: convert address information in the first message into a physical address; and send the first message whose address has been converted to the secure operating system through a secure monitor. The message sending unit 42 may convert the address information into a physical address, thereby determining the destination of the first message and accurately sending the first message. Herein, the address information in the first message may be, for example, but not limited to, an intermediate physical address. For example, the middleware converts the intermediate physical address in the first message into a physical address and records it.

The processed message receiving unit 43 is configured to receive from the secure operating system a second message obtained by performing processing based on the first message. The second message includes second storage location information of a result of the processing in the shared memory.

In an exemplary embodiment of the present disclosure, the second message may further include the virtual machine flag, identifying the virtual machine corresponding to the second message.

The processed message sending unit 44 is configured to send the second message to the virtual machine.

In an exemplary embodiment of the present disclosure, the processed message sending unit 44 may be configured to: determine the virtual machine indicated by the virtual machine flag included in the second message; and send the second message with the virtual machine flag removed to the virtual machine.

In an exemplary embodiment of the present disclosure, the first message may further include a function that the virtual machine needs the secure operating system to complete.

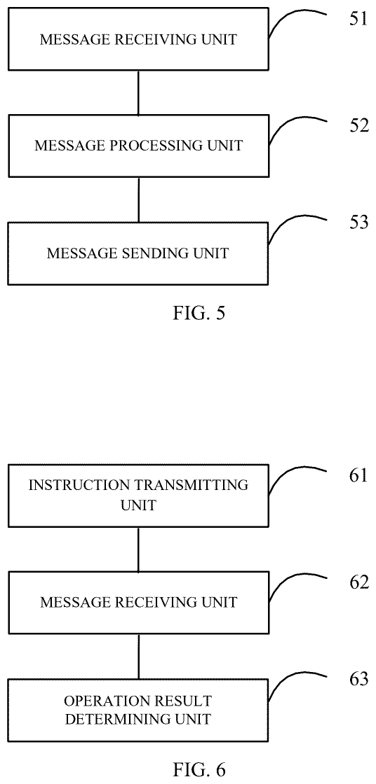

FIG. 5 illustrates a block diagram of a secure operating system according to an exemplary embodiment of the present disclosure.

Referring to FIG. 5, the secure operating system includes a message receiving unit 51, a message processing unit 52, and a message sending unit 53.

The message receiving unit 51 is configured to receive a first message sent from a middleware of a Hypervisor. In embodiments the first message includes first storage location information of data associated with the first message in a shared memory where the shared memory is located in the middleware. In an exemplary embodiment of the present disclosure, for example, the secure operating system may be located in a trusted execution environment.

In an exemplary embodiment of the present disclosure, the first message may further include a virtual machine flag, the virtual machine flag may be used to indicate a virtual machine corresponding to the first message.

In an exemplary embodiment of the present disclosure, the first message may further include a function that the virtual machine needs the secure operating system to complete.

The message processing unit 52 is configured to perform processing based on the first message to obtain a second message. This second message includes second storage location information of a result of the processing in the shared memory. Herein, the processing performed by the secure operating system based on the first message may also be referred to as trusted service processing.

In an exemplary embodiment of the present disclosure, the message processing unit 52 may be configured to: acquire data associated with the first message from the shared memory based on first storage location information; and process the acquired data associated with the first message.

In an exemplary embodiment of the present disclosure, the first message may further include a function that the virtual machine needs the secure operating system to complete.

In an exemplary embodiment of the present disclosure, the message processing unit 52 may be configured to: process the acquired data associated with the first message based on the function.

The message sending unit 53 is configured to send the second message to the middleware.

In an exemplary embodiment of the present disclosure, the second message may further include the virtual machine flag, identifying the virtual machine corresponding to the second message which is the virtual machine to which the second message is to be sent.

FIG. 6 illustrates a block diagram of a virtual machine according to an exemplary embodiment of the present disclosure.

Referring to FIG. 6, the virtual machine includes an instruction transmitting unit 61, a message receiving unit 62, and an operation result determining unit 63.

The instruction transmitting unit 61 is configured to transmit a first message to be sent to a secure operating system through a call instruction. The first message includes first storage location information of data associated with the first message in a shared memory, the shared memory is located in the middleware included in a Hypervisor. For example, the secure operating system may be located in a trusted execution environment.

The message receiving unit 62 is configured to receive a second message sent from the middleware and obtained by the secure operating system through performing processing based on the first message. The second message includes second storage location information of a result of the processing in the shared memory; and

The operation result determining unit 63 is configured to determine an operation result based on the second message.

In an exemplary embodiment of the present disclosure, the operation result determining unit 63 may be configured to: acquire the result of the processing from the shared memory based on the second storage location information; and determine the acquired result of the processing as the operation result.

FIG. 7 illustrates a schematic diagram of a virtual machine operating system according to an exemplary embodiment of the present disclosure.

Referring to FIG. 7, the virtual machine operating system includes: at least one virtual machine (for example, the two virtual machines in FIG. 7); at least one secure operating system (Secure OS); a Hypervisor, including a middleware. The middleware is connected to the at least one virtual machine and a secure monitor, with the at least one secure operating system is registered in the middleware. The middleware is not bound to any particular secure operating system, and the middleware may support a variety of secure operating systems. For example, the at least one secure operating system may be located in a trusted execution environment (TEE). Two virtual machines are used only as an example in FIG. 7, and the present disclosure is not limited thereto.

As shown in FIG. 7, the middleware includes a message manager, a virtual machine manager, and a world shared memory (WSM) manager. The message manager includes a message stamper, a message filter, and a message dispatcher. The message stamper is used to add a stamp (including, for example, but not limited to, a virtual machine flag and intermediate physical address (IPA)/physical address (PA) information) into a message. The message filter is used to filter out a message that is not destined for a secure operating system. A message dispatcher is used to distribute returned messages to the corresponding virtual machines.

The Virtual Machine Manager (VM Manager) is used to manage each of the multiple virtual machines. The virtual machine manager includes a system page and a message ring (for example, the MSG RING in FIG. 7). The message ring is used to temporarily store messages for filtering purposes. The system page registers a system page for the secure operating system to manage the state of each of the multiple virtual machines. As an example, the system page maintains some basic information about the virtual machines, including the number of virtual machines, the ID of the virtual machines, and whether the virtual machines are alive or not. The virtual machines can access the system page in running (to know the status of the secure operating system, such as whether the secure operating system is alive or not) and whether the secure operating system is still working properly. The number of VMs can be dynamically configured through the system page, which enables increasing and decreasing the number of the VMs without any amendment of the VMs. Since the states of all the virtual machines are managed in the system page, the secure operating system does not need to know how many virtual machines there are so that the secure operating system does not need any amendment.

The world shared memory manager is used to manage the shared memory between the virtual machines and the secure operating system. The world shared memory manager may include hash tables. The world shared memory manager uses a hash algorithm to manage the shared memory or the world shared memory between the multiple virtual machines and the secure operating systems.

The hash algorithm is a commonly used algorithm for quickly finding data through an identity (ID). In the present disclosure, the hash algorithm is used to find the physical address of the world shared memory through the identity of the world shared memory. However, the disclosure is not limited thereto.

The specific process of managing the world shared memory using the hash algorithm is as follows: during the initialization phase of the middleware, a hash table (hash_table) with length n is created; after the middleware receives a message from the virtual machines, it obtains the world shared memory identity (WSM ID) in the message. Then, the index of the hash table (index=(WSM ID) mod n) is calculated by the world shared memory identity (WSM ID); and using the index value, a table entry of the hash table is found. Then the physical address of the world shared memory (WSM) is stored in this table entry (hash_table[index]). After the message is processed by the secure operating system, the middleware looks up the physical address of the world shared memory (WSM) in the hash table by the WSM ID (hash_table[(WSM ID) mod n]), and this operation has a time complexity of O(1), so the most efficient lookup speed can be obtained.

In an exemplary embodiment of the present disclosure, the middleware is configured to: acquire a first message to be sent by the at least one virtual machine to the at least one secure operating system, wherein the first message includes first storage location information of data associated with the first message in a shared memory, the shared memory is located in the middleware; send the first message to the at least one secure operating system; receive from the at least one secure operating system a second message obtained by performing processing based on the first message, wherein the second message includes second storage location information of a result of the processing in the shared memory; and send the second message to the at least one virtual machine.

In an exemplary embodiment of the present disclosure, the middleware may be further configured to: acquire transmission messages transmitted by the at least one virtual machine through a call instruction; determine a target transmission message in the transmission messages whose destination is the secure operating system; and determine the first message based on the target transmission message, thereby filtering out messages that are not to be send to the secure operating system to improve efficiency. For example, the middleware may acquire a transmission message transmitted by the at least one virtual machine through a call instruction, by way of interception. Herein, the call instruction may be a secure monitor call instruction.

In an exemplary embodiment of the present disclosure, the first message may further include a virtual machine flag, the virtual machine flag may be used to indicate a virtual machine corresponding to the first message, and the second message further includes the virtual machine flag, thus implements the marking of the first message and the second message.

In an exemplary embodiment of the present disclosure, the first message may further include a function that the at least one virtual machine needs the secure operating system to complete.

In an exemplary embodiment of the present disclosure, the middleware may be further configured to: append the virtual machine flag into a session field of the target transmission message; and determine the target transmission message with the virtual machine flag appended as the first message, thus implements the marking of the first message. For example, if a destination of a transmission message is the secure operating system, the middleware determines that the transmission message is the target transmission message, decodes the target transmission message, and appends the virtual machine flag into the session field of the target transmission message, thereby obtaining the first message.

In an exemplary embodiment of the present disclosure, the middleware may be further configured to: convert address information in the first message into a physical address; and send the first message whose address has been converted to the secure operating system through a secure monitor. Herein, the address information is converted into a physical address, thereby determining the destination of the first message and accurately sending the first message. Herein, the address information in the first message may be, for example, but not limited to, an intermediate physical address. For example, the middleware converts the intermediate physical address in the first message into a physical address and records it.

In an exemplary embodiment of the present disclosure, the second message may further include the virtual machine flag, thereby facilitating the determination of the virtual machine corresponding to the second message.

In an exemplary embodiment of the present disclosure, the middleware may be further configured to: determine the virtual machine indicated by the virtual machine flag included in the second message; and send the second message with the virtual machine flag removed to the virtual machine. Herein, the second message with the virtual machine flag removed may be sent to the virtual machine. Herein, the distribution of the returned second message is implemented based on the virtual machine flag, thereby improving the accuracy of the sending of the second message. Since the second message includes the virtual machine flag, the middleware may correctly distribute the second message to the corresponding virtual machine.

In an exemplary embodiment of the present disclosure, the middleware may include a system page for the at least one secure operating system, the system page is used to manage the state of the at least one virtual machine and the at least one secure operating system.

In an exemplary embodiment of the present disclosure, the middleware may include a message ring for storing transmission messages acquired from the at least one virtual machine.

In an exemplary embodiment of the present disclosure, the middleware may include a memory manager, the shared memory may be located in the memory manager, wherein the shared memory is a memory shared by the at least one virtual machine and the at least one secure operating system, and wherein the memory manager may manage the shared memory.

In an exemplary embodiment of the present disclosure, each of the at least one secure operating system may be configured to: receive a first message sent from the middleware, wherein the first message includes first storage location information of data associated with the first message in a shared memory, the shared memory is located in the middleware; perform processing based on the first message to obtain a second message, wherein the second message includes second storage location information of a result of the processing in the shared memory; and send the second message to the middleware.

In an exemplary embodiment of the present disclosure, each of the at least one secure operating system may be configured to: acquire data associated with the first message from the shared memory based on first storage location information; and process the acquired data associated with the first message, thereby avoiding the sending of the data by determining the data based on the first stored location information in the first message.

In an exemplary embodiment of the present disclosure, each of the at least one secure operating system may be configured to: process the acquired data associated with the first message based on the function.

In an exemplary embodiment of the present disclosure, each of the at least one virtual machine may be configured to: transmit a first message to be sent to the at least one secure operating system through a call instruction, wherein the first message includes first storage location information of data associated with the first message in the shared memory; receive a second message sent from the middleware and obtained by the at least one secure operating system through performing processing based on the first message, wherein the second message includes second storage location information of a result of the processing in the shared memory; and determine an operation result based on the second message.

In an exemplary embodiment of the present disclosure, each of the at least one virtual machine may be configured to: acquire the result of the processing from the shared memory based on the second storage location information; and determine the acquired result of the processing as the operation result, thereby making it unnecessary to send the result of the processing on the data by using the shared memory in the middleware, and the result of the processing on the data will not be exposed, thereby improving security and efficiency.

The virtual machine operating system according to the exemplary embodiments of the present disclosure, implements the function of supporting the secure operating system for multiple virtual machines by using the middleware only in the Hypervisor, so that there is no need to amend the secure operating system and the virtual machines, and it is more convenient to support multiple secure operating systems, which improves scalability, and makes it unnecessary, by using the shared memory in the middleware, to send data and result of the processing on the data, and the data and the result of the processing on the data cannot be exposed, which improves security and efficiency.

In addition, according to embodiments of the present disclosure, there also provides a non-transitory computer-readable storage medium having a computer program stored thereon, and when the computer program is executed, the operation method according to the embodiments of the present disclosure is implemented.

In exemplary embodiments of the present disclosure, the computer-readable storage medium may carry one or more programs that, when executed, may implement the following operations: acquiring a first message to be sent by a virtual machine to a secure operating system registered in a middleware of the Hypervisor, wherein the first message includes first storage location information of data associated with the first message in a shared memory, the shared memory is located in the middleware; sending the first message to the secure operating system; receiving from the secure operating system a second message obtained by performing processing based on the first message, wherein the second message includes second storage location information of a result of the processing in the shared memory; and sending the second message to the virtual machine.

In exemplary embodiments of the present disclosure, the computer-readable storage medium may carry one or more programs that, when executed, may implement the following operations: receiving a first message sent from a middleware of a Hypervisor, wherein the first message includes first storage location information of data associated with the first message in a shared memory, the shared memory is located in the middleware; performing processing based on the first message to obtain a second message, wherein the second message includes second storage location information of a result of the processing in the shared memory; and sending the second message to the middleware.

In exemplary embodiments of the present disclosure, the computer-readable storage medium may carry one or more programs that, when executed, may implement the following operations: transmitting a first message to be sent to a secure operating system through a call instruction, wherein the first message includes first storage location information of data associated with the first message in a shared memory, the shared memory is located in the middleware included in a Hypervisor; receiving a second message sent from the middleware and obtained by the secure operating system through performing processing based on the first message, wherein the second message includes second storage location information of a result of the processing in the shared memory; and determining an operation result based on the second message.

The computer-readable storage medium can be, for example, but not limited to, an electrical, magnetic, optical, electromagnetic, infrared, or semiconductor system, apparatus or device, or any combination of the above. Examples of the computer readable storage medium include: read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), a card type memory such as multimedia card, secure digital (SD) card or extreme digital (XD) card, magnetic tapes, floppy disks, magneto-optical data storage devices, optical data storage devices, hard disks, solid-state disks, and any other device that is configured to store computer program and any associated data, data files, and data structures in a non-transitory manner and providing the computer program and any associated data, data files, and data structures to a processor or computer so that the processor or computer can execute the computer program.

In addition, according to exemplary embodiments of the present disclosure, there also provided a computer program product, wherein instructions in the computer program product can be executed by a processor of the computer device to implement the operation method according to the exemplary embodiments of the present disclosure.

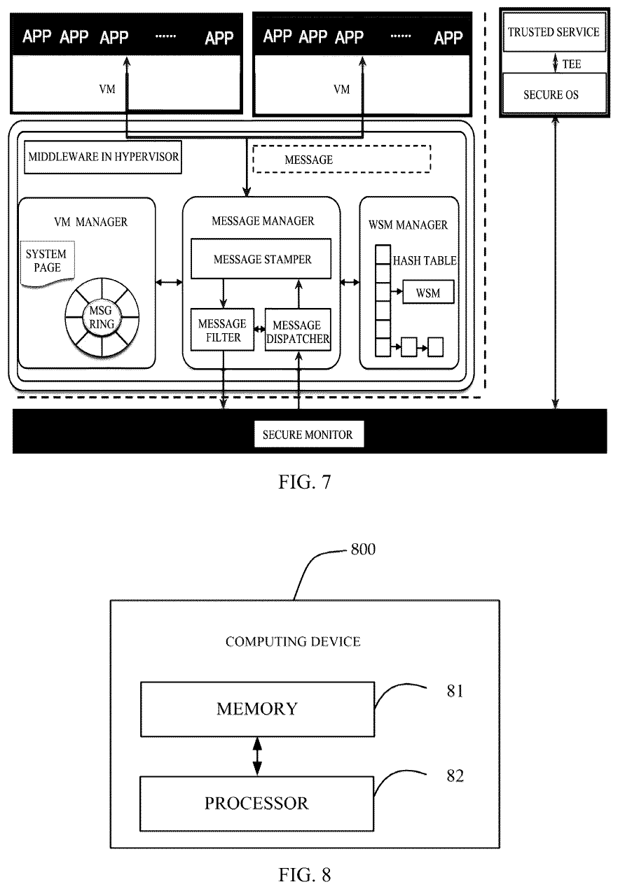

The Hypervisor, the secure operating system, the virtual machine and the virtual machine operating system according to the exemplary embodiments of the present disclosure have been described above in conjunction with FIG. 4 to FIG. 7. Next, a computing device according to the exemplary embodiment of the present disclosure will be described in conjunction with to FIG. 8.

FIG. 8 shows a schematic diagram of the computing device according to an exemplary embodiment of the present disclosure.

Referring to FIG. 8, the computing device 800 may include memory 81 and processor 82, and the memory 81 stores one or more computer programs. The memory 81 may include one or more memory devices and/or structure. The processor 82 may include one or more processors, executing instructions individually or in combination. When the computer program is executed by the processor 82, the operation method according to the exemplary embodiments of the present disclosure is implemented.

In the exemplary embodiments of the present disclosure, when the computer program is executed by the processor 82, it may implement the following steps of acquiring a first message to be sent by a virtual machine to a secure operating system registered in a middleware of the Hypervisor, wherein the first message includes first storage location information of data associated with the first message in a shared memory, the shared memory is located in the middleware; sending the first message to the secure operating system; receiving from the secure operating system a second message obtained by performing processing based on the first message, wherein the second message includes second storage location information of a result of the processing in the shared memory; and sending the second message to the virtual machine.

In the exemplary embodiments of the present disclosure, when the computer program is executed by the processor 82, it may implement the following steps of receiving a first message sent from a middleware of a Hypervisor, wherein the first message includes first storage location information of data associated with the first message in a shared memory, the shared memory is located in the middleware; performing processing based on the first message to obtain a second message, wherein the second message includes second storage location information of a result of the processing in the shared memory; and sending the second message to the middleware.

In the exemplary embodiments of the present disclosure, when the computer program is executed by the processor 82, it may implement the following steps of transmitting a first message to be sent to a secure operating system through a call instruction, wherein the first message includes first storage location information of data associated with the first message in a shared memory, the shared memory is located in the middleware included in a Hypervisor; receiving a second message sent from the middleware and obtained by the secure operating system through performing processing based on the first message, wherein the second message includes second storage location information of a result of the processing in the shared memory; and determining an operation result based on the second message.

The computing devices in embodiments of the present disclosure may include, but are not limited to, devices such as mobile phones, notebook computers, PDAs (personal digital assistants), PADs (tablet computers), desktop computers, and the like. The computing device shown in FIG. 8 is only an example, and should not impose any limitation on the function and scope of use of the embodiments of the present disclosure.

The operation method and device, system, computer-readable storage medium, and computing device according to the exemplary embodiments of the present disclosure have been described above with reference to FIG. 1-FIG. 8. However, it should be understood that the Hypervisor and the units thereof, the secure operating system and the units thereof, the virtual machine and the units thereof shown in FIG. 4-FIG. 6 may be respectively configured with software, hardware, firmware or any combination of the above to perform specific functions, and the computing device shown in FIG. 8 is not limited to include the above shown components, but some components may be added or deleted according to needs, and the above components may also be combined.

The operation method for the Hypervisor and the device according to an exemplary embodiment of the present disclosure, by acquiring a first message to be sent by a virtual machine to a secure operating system registered in a middleware of the Hypervisor, wherein the first message includes first storage location information of data associated with the first message in a shared memory, the shared memory is located in the middleware, sending the first message to the secure operating system, receiving from the secure operating system a second message obtained by performing processing based on the first message, wherein the second message includes second storage location information of a result of the processing in the shared memory, and sending the second message to the virtual machine, improves scalability, security, and flexibility of operations of the virtual machine and improves operation efficiency of the virtual machine, by using the middleware to support the use of functions and services of secure operating system across multiple virtual machines.

The operation method for the secure operating system according to an exemplary embodiment of the present disclosure, by receiving a first message sent from a middleware of a Hypervisor, wherein the first message includes first storage location information of data associated with the first message in a shared memory, the shared memory is located in the middleware, performing processing based on the first message to obtain a second message, wherein the second message includes second storage location information of a result of the processing in the shared memory, and sending the second message to the middleware, makes it unnecessary, by using the shared memory in the middleware of the Hypervisor, to send data and the result of the processing on the data, so that the data and the result of the processing on the data cannot be exposed, which improves security and efficiency.

The operation method for the virtual machine according to an exemplary embodiment of the present disclosure, by transmitting a first message to be sent to a secure operating system through a call instruction, wherein the first message includes first storage location information of data associated with the first message in a shared memory, the shared memory is located in the middleware included in a Hypervisor, receiving a second message sent from the middleware and obtained by the secure operating system through performing processing based on the first message, wherein the second message includes second storage location information of a result of the processing in the shared memory, and determining an operation result based on the second message, makes it unnecessary, by using the shared memory in the middleware of the Hypervisor, to send the result of the processing on data, so that the result of the processing on the data cannot be exposed, which improves security and efficiency.

At least one of the components, elements, modules and units (collectively “components” in this paragraph) represented by a block in the drawings such as FIGS. 4-8 may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU), a microprocessor, or the like that performs the respective functions.

Although the present disclosure has been specifically shown and described with reference to the exemplary embodiments thereof, those skilled in the art should understand that various changes of the forms and details can be made without departing from the spirit and scope of the present disclosure as defined by the claims.

1. An operation method for a Hypervisor, the operation method executed by one or more processors, the operation method comprising:
acquiring a first message, the first message being a message to be sent from a virtual machine to a secure operating system, the secure operating system being registered in a middleware of the Hypervisor, wherein the first message comprises a first storage location information of data associated with the first message, the first storage location information being associated with a first location in a memory in the middleware associated with the virtual machine and the secure operating system;
sending the first message to the secure operating system;
receiving, from the secure operating system, a second message, the second message being based on the first message, wherein the second message comprises a second storage location information of a result based on processing the first message, the second storage location information being associated with a second location in a memory in the middleware; and
sending the second message to the virtual machine.

2. The operation method according to claim 1, wherein the acquiring of the first message comprises:
acquiring one or more transmission messages transmitted by the virtual machine through one or more call instructions;
determining, as a target transmission message, a message having the secure operating system as a destination among the one or more transmission messages; and
determining the first message based on the target transmission message.

3. The operation method according to claim 1, wherein the first message further comprises a virtual machine flag, the virtual machine flag indicating a first virtual machine corresponding to the first message, and
wherein the second message further comprises the virtual machine flag.

4. The operation method according to claim 3, wherein the determining of the first message based on the target transmission message comprises:
updating a session field of the target transmission message based on the virtual flag; and
determining the target transmission message as the first message.

5. The operation method according to claim 1, wherein the sending of the first message to the secure operating system comprises:
converting address information in the first message into a physical address; and
sending the first message to the secure operating system through a secure monitor.

6. The operation method according to claim 3, wherein the sending of the second message to the virtual machine comprises:
determining the first virtual machine indicated by the virtual machine flag in the second message; and
sending the second message without the virtual machine flag to the first virtual machine.

7. The operation method according to claim 3, wherein the first message further comprises a function for the secure operating system to execute.

8-14. (canceled)

15. A virtual machine operating system comprising:
at least one virtual machine;
at least one secure operating system;
a Hypervisor, comprising a middleware, wherein the middleware is connected to the at least one virtual machine, and wherein the at least one secure operating system is registered with the middleware; and
a secure monitor, connected to the middleware and the at least one secure operating system,
wherein one or more processors in the middleware are configured to:
acquire a first message, the first message being a message to be sent from the at least one virtual machine to the at least one secure operating system, wherein the first message comprises a first storage location information of data associated with the first message, the first storage location information being associated with a first location in a memory in the middleware associated with the virtual machine and the secure operating system;
send the first message to the at least one secure operating system;
receive, from the at least one secure operating system, a second message, the second message being based on the first message, wherein the second message comprises a second storage location information of a result based on processing the first message, the second storage location information being associated with a second location in a memory in the middleware; and
send the second message to the at least one virtual machine.

16. The virtual machine operating system according to claim 15, wherein the middleware comprises a system page for the at least one secure operating system, the system page being used to manage a state of the at least one virtual machine and a state of the at least one secure operating system.

17. The virtual machine operating system according to claim 15, wherein the middleware comprises a message ring for storing one or more transmission messages acquired from the at least one virtual machine.

18. The virtual machine operating system according to claim 15, wherein the middleware comprises a memory manager, the memory is in the memory manager, wherein the memory is shared by the at least one virtual machine and the at least one secure operating system, and wherein the memory manager manages the memory.

19. The virtual machine operating system according to claim 15, wherein each of the at least one secure operating system is configured to:
receive the first message sent from the middleware;
obtain the second message based on the first message to ; and
send the second message to the middleware.

20. The virtual machine operating system according to claim 15, wherein each of the at least one virtual machine is configured to:
transmit the first message using a call instruction;
receive the second message sent from the middleware, the second message being obtained by the at least one secure operating system based on the first message; and
determine an operation result based on the second message.

21. A Hypervisor comprising:
a message acquiring unit, configured to acquire a first message, the first message being a message to be sent from a virtual machine to a secure operating system registered in a middleware of the Hypervisor, wherein the first message comprises a first storage location information of data associated with the first message, the first storage location information being associated with a first location in a memory in the middleware associated with the virtual machine and the secure operating system;
a message sending unit, configured to send the first message to the secure operating system;
a processed message receiving unit, configured to receive, from the secure operating system, a second message, the second message being based on the first message, wherein the second message comprises a second storage location information of a result based on processing the first message, the second storage location information being associated with a second location in a memory in the middleware; and
a processed message sending unit, configured to send the second message to the virtual machine.

22. The Hypervisor according to claim 21, wherein the message acquiring unit is further configured to:
acquire one or more transmission messages transmitted by the virtual machine through one or more call instructions;
determine, as a target transmission message, a message having the secure operating system as a destination among the one or more the transmission messages; and
determine the first message based on the target transmission message.

23. The Hypervisor according to claim 21, wherein the first message further comprises a virtual machine flag, the virtual machine flag indicating a first virtual machine corresponding to the first message, and
wherein the second message further comprises the virtual machine flag.

24. The Hypervisor according to claim 23, wherein the message acquiring unit is further configured to:
update a session field of the target transmission message based on the virtual flag; and
determine the target transmission message as the first message.

25. The Hypervisor according to claim 21, wherein the message sending unit is further configured to:
convert address information in the first message into a physical address; and
send the first message to the secure operating system through a secure monitor.

26. The Hypervisor according to claim 23, wherein the processed message sending unit is further configured to:
determine the first virtual machine indicated by the virtual machine flag in the second message; and
send the second message without the virtual machine flag to the first virtual machine.

27. The Hypervisor according to claim 23, wherein the first message further comprises a function for the secure operating system to execute.

28-36. (canceled)
